(19) United States
(12) Patent Application Publication
(10) Pub. No.: US 2014/0041875 A1
(43) Pub. Date: Feb. 13, 2014

(54) ALKYLARYL SULPHONATE COMPOSITIONS AND USE THEREOF FOR THE ENHANCED RECOVERY OF HYDROCARBONS

(71) Applicants: Maurice Bourrel, Pau (FR); Manuel Chamerois, Denguin (FR); Nicolas Agenet, Bonnut (FR)

(72) Inventors: Maurice Bourrel, Pau (FR); Manuel Chamerois, Denguin (FR); Nicolas Agenet, Bonnut (FR)

(73) Assignee: TOTAL S.A., Courbevoie (FR)

(21) Appl. No.: 14/112,118

(22) PCT Filed: Apr. 13, 2012
(86) PCT No.: PCT/EP2012/056857

§ 371 Date: Oct. 16, 2013

(30) Foreign Application Priority Data
Apr. 18, 2011 (FR) 1153360

(51) Int. Cl. C09K 8/584; E21B 43/16

(52) U.S. Cl. CPC C09K 8/584; E21B 43/16
USPC 166/305.1; 507/259

(57) ABSTRACT

A surfactant composition includes an alkaryl sulphonate compound (a) and an alkaryl sulphonate compound (b). The difference between the optimum salinity of compound (a) and the optimum salinity of compound (b) is greater than or equal to 3 g/L. The surfactant composition can easily be adapted to various operating conditions, and in particular to various conditions of salinity, in order to provide optimum enhanced oil recovery.

### CROSS-REFERENCE TO RELATED APPLICATIONS

This application is a National Phase Entry of International Application No. PCT/EP2012/056857, filed on Apr. 13, 2012, which claims priority to French Patent Application Serial No. 1153360, filed on Apr. 18, 2011, both of which are incorporated by reference herein.

### FIELD OF THE INVENTION

The present invention relates to alkaryl sulphonate compositions and use thereof in the context of enhanced oil recovery (EOR).

### BACKGROUND

The crude oil that has accumulated in an underground reservoir is recovered or produced by means of one or more wells drilled in the reservoir. Before production begins, the formation (a porous medium) is saturated with hydrocarbons and the pores are filled with these hydrocarbons.

The initial recovery of hydrocarbons is generally carried out by techniques of “primary recovery”, in which only the natural forces present in the reservoir are utilized for producing the petroleum. In this primary recovery, only a proportion of the crude oil is ejected from the pores by the pressure of the formation. Typically, once the natural forces are exhausted and primary recovery is completed, there is still a large volume of crude oil in the reservoir, generally more than two thirds.

This phenomenon has been known for a long time and has led to the development of many techniques of enhanced oil recovery. A high proportion of these techniques envisage the injection of a fluid into the underground reservoir in order to produce an additional quantity of crude oil. The fluid used is water, steam, a miscible gas such as carbon dioxide or natural gas, or an immiscible gas such as nitrogen.

Water is the fluid most widely used, in particular for economic reasons. When water is injected into the reservoir, it propels the petroleum towards a production system composed of one or more wells through which the petroleum is recovered. However, displacement of petroleum by water is not very effective, owing to:
poor volume flushing, due to the heterogeneities of the porous medium at the scale of the reservoir; and
poor microscopic recovery due to the immiscibility of water and petroleum and the high interfacial tension between the two phases, which leads to capillary trapping of the oil droplets.

In order to increase the microscopic efficiency of enhanced oil recovery by water injection, it is known to add surfactants to the water to lower the oil/water interfacial tension. Microemulsions have a zero or very low interfacial tension with oil, making it possible to mobilize the hydrocarbons trapped in the pores in the rock. Thus, the drops of petroleum are deformed more easily, and are therefore displaced more easily through the porous channels of the reservoir.

It is in the conditions of formation of a microemulsion that the oil recovery potential is highest. However, the conditions of formation of the microemulsion depend on several factors, in particular the type of surfactant used, the nature of the oil (mainly its content of naphthenates or TAN and its density/viscosity), the salinity of the aqueous phase etc. Finally, the optimum conditions for oil recovery depend on all of these parameters taken together. The optimum conditions are validated and refined case by case, using flushing operations carried out on core samples.

The use of sulphonates, and in particular alkaryl sulphonates, as surfactants is known. Alkaryl sulphonates suitable for enhanced oil recovery (as well as combinations of alkaryl sulphonates) are described for example in documents EP 0111354, EP 0158486, U.S. Pat. No. 3,601,198, U.S. Pat. No. 4,452,708, U.S. Pat. No. 4,608,204, U.S. Pat. No. 4,682,653, U.S. Pat. No. 4,690,785, U.S. Pat. No. 4,873,025, U.S. Pat. No. 6,043,391 and U.S. Pat. No. 6,269,881. Combinations of alkaryl sulphonates and polysaccharides have also been proposed (for example in document U.S. Pat. No. 4,932,473), as well as combinations of alkaryl sulphonates and glycol (for example in document EP 0413374), or combinations of alkaryl sulphonates and polyisobutylene (for example in document WO 01/98432), or also combinations of alkaryl sulphonates and alpha-olefin sulphonates (for example in document EP 0148517).

One problem with ionic surfactants of the alkaryl sulphonate type is that their physicochemical properties are highly dependent on the salinity of the aqueous phase. At low salinity, the surfactants are located preferentially in the aqueous lower phase, where they form microemulsions of the oil-in-water type, the excess oil being located in the upper phase. At high salinity, these surfactants are located preferentially in the oily upper phase, where they form microemulsions of the water-in-oil type, the excess water being located in the lower phase.

In an intermediate range of salinity, a microemulsion phase appears between the aqueous and oily phases. In this range of salinity, the microemulsion phase contains variable quantities of oil and water.

There is a so-called optimum salt concentration, such that the conditions of interfacial tension reach a minimum. For this optimum salt concentration, the volumes of water and of oil in the microemulsion are identical. This type of microemulsion leads to better mobilization of the hydrocarbons. This means that each anionic surfactant of the alkaryl sulphonate type only has an optimum efficiency for a particular salinity, called the optimum salinity.

Conversely, for given conditions of salinity, it is known to try to find a type of alkaryl sulphonate having an optimum oil recovery potential. For example, document WO 2005/018300 identifies alkylxylene sulphonates that are particularly suitable for enhanced oil recovery when the salinity is between 0.2 and 0.5% (i.e. between 2 and 5 g/L). Thus, in view of the great variety of surfactants that can be envisaged, it can be a long and difficult process to identify surfactants permitting optimum oil recovery for given operating conditions (in particular the salinity of the water and the physicochemical characteristics of the hydrocarbons).

There is therefore a real need to develop surfactant compositions that can easily be adapted to various operating conditions, and in particular to various conditions of salinity, to provide optimum enhanced oil recovery. More particularly, there is a need to develop surfactant compositions permitting optimum enhanced oil recovery when the water is of low salinity, for example salinity between 0.1 and 2 g/L, and in particular between 0.5 and 1.5 g/L.

### SUMMARY

The invention relates firstly to a surfactant composition comprising an alkaryl sulphonate compound (a), and an alkaryl sulphonate compound (b). The difference between the optimum salinity of compound (a) and the optimum salinity of compound (b) is greater than or equal to 3 g/L. The optimum salinity of a compound is defined as that concentration of sodium chloride in water at which said compound, when it is added at a content of 3.6% by weight of dry matter to an isovolumetric decane/water mixture, in the presence of 5.4% of secondary butanol, at atmospheric pressure and at 50° C., generates a three-phase mixture comprising an upper phase of decane; a lower phase of water; and an intermediate phase which is an emulsion consisting of water, decane and said compound; in which the intermediate phase has an equal volume of decane and water.

According to examples, the composition can comprise one or more of the following characteristics:

the difference between the optimum salinity of compound (a) and the optimum salinity of compound (b) is greater than or equal to 5 g/L, preferably greater than or equal to 10 g/L;

compound (b) has an optimum salinity below 5 g/L, preferably less than or equal to 4 g/L, more particularly preferably less than or equal to 3 g/L;

compound (a) has an optimum salinity above 8 g/L, preferably greater than or equal to 10 g/L, more particularly preferably greater than or equal to 15 g/L;

the surfactant composition comprises:
an alkaryl sulphonate compound of formula (I):

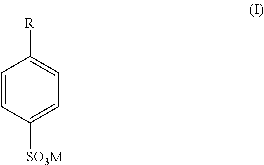

and an alkaryl sulphonate compound of formula (II):

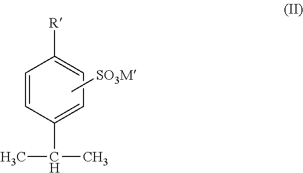

R and R′ each representing an alkyl group, and M and M′ each representing a monovalent cation;

in the compound of formula (I), group R comprises from 12 to 24 carbon atoms, preferably from 16 to 20 carbon atoms; and/or in the compound of formula (II), group R′ comprises from 10 to 24 carbon atoms, preferably from 14 to 18 carbon atoms;

M and M′ are each a sodium cation;

in compound (I), from 1 to 50% of groups R are bound at their position 2, preferably from 5 to 30%, more particularly preferably from 10 to 20%; and/or in compound (II), from 1 to 50% of groups R′ are bound at their position 2, preferably from 5 to 30%, more particularly preferably from 10 to 20%;

in compound (I), from 10 to 60% of groups R are branched, preferably from 20 to 50%, more particularly preferably from 30 to 40%; and/or in compound (II), from 0.5 to 20% of groups R′ are branched, preferably from 1 to 15%, more particularly preferably from 2 to 8%;

the composition comprises from 1 to 99% of compound (I), preferably from 40 to 95%, more particularly preferably from 60 to 90%, relative to the total weight of compounds (I) and (II); and/or from 1 to 99% of compound (II), preferably from 5 to 60%, more particularly preferably from 10 to 40%, relative to the total weight of compounds (I) and (II);

the difference between the optimum salinity of compound (I) and the optimum salinity of compound (II) is greater than or equal to 3 g/L, preferably greater than or equal to 5 g/L, ideally greater than or equal to 10 g/L, the optimum salinity of a compound being defined as that concentration of sodium chloride in water at which said compound, when it is added at a content of 3.6% by weight of dry matter to an isovolumetric decane/water mixture, in the presence of 5.4% of secondary butanol, at atmospheric pressure and at 50° C., generates a three-phase mixture comprising: an upper phase of decane; a lower phase of water; and an intermediate phase which is an emulsion consisting of water, decane and said compound; in which the intermediate phase has an equal volume of decane and water;

compound (I) has an optimum salinity greater than or equal to 8 g/L, preferably greater than or equal to 10 g/L, more particularly preferably greater than or equal to 15 g/L; and/or compound (II) has an optimum salinity less than or equal to 5 g/L, preferably less than or equal to 4 g/L, more particularly preferably less than or equal to 3 g/L;

the composition further comprises one or more additives selected from salts, additional surfactants, sacrificial agents, polymers for controlling mobility, agents for pH adjustment and mixtures thereof; and/or

the composition is in dry form or in the form of aqueous solution, the proportion by weight of alkaryl sulphonates in the aqueous solution preferably being between 0.2% and 2%.

The invention also relates to a method of extracting hydrocarbons from an underground formation, comprising the injection of a surfactant composition as described above in the form of aqueous solution into the underground formation, and the production of hydrocarbons displaced by the injected surfactant composition. The invention also relates to a method of obtaining a surfactant composition suitable for enhanced oil recovery in an underground formation comprising: estimation of the salinity of the underground formation; supplying a plurality of candidate surfactant compositions, each comprising a first alkaryl sulphonate compound (a) and a second alkaryl sulphonate compound (b); mixing each candidate surfactant composition with an aqueous solution having a salinity equal to the estimated salinity of the underground formation, and with a sample of liquid hydrocarbons obtained from the underground formation, for supplying a candidate mixture; selecting a surfactant composition from the set of candidate surfactant compositions, the candidate mixture combined with the selected surfactant composition being a three-phase mixture comprising an upper phase of liquid hydrocarbons; a lower phase of aqueous solution; and an intermediate phase which is an emulsion consisting of aqueous solution, liquid hydrocarbons and compounds (a) and (b).

According to examples, the method can comprise one or more of the following features:

the intermediate phase of the candidate mixture combined with the selected surfactant composition comprises an equal volume of liquid hydrocarbons and aqueous solution;

the method comprises:
after estimating the salinity of the underground formation:
   selecting an alkaryl sulphonate compound having an optimum salinity higher than the estimated salinity of the underground formation, as alkaryl sulphonate compound (a) for all of the candidate surfactant compositions; and
   selecting an alkaryl sulphonate compound having an optimum salinity lower than the estimated salinity of the underground formation, as alkaryl sulphonate compound (b) for all of the candidate surfactant compositions;
and in which the weight ratio of alkaryl sulphonate compound (a) to alkaryl sulphonate compound (b) varies depending on the candidate surfactant compositions;
the optimum salinity of a compound being defined as that concentration of sodium chloride in water at which said compound, when it is added at a content of 3.6% by weight of dry matter to an isovolumetric decane/water mixture, in the presence of 5.4% of secondary butanol, at atmospheric pressure and at 50° C., generates a three-phase mixture comprising:
an upper phase of decane;
a lower phase of water; and
an intermediate phase which is an emulsion consisting of water, decane and said compound;
in which the intermediate phase has an equal volume of decane and water;

the difference between the optimum salinity of compound (a) and the optimum salinity of compound (b) is greater than or equal to 3 g/L, preferably greater than or equal to 5 g/L, more particularly preferably greater than or equal to 10 g/L; and/or

the alkaryl sulphonate compound (a) is an alkaryl sulphonate of formula (I):

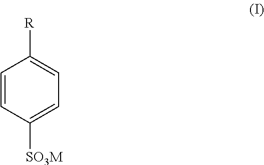

and the alkaryl sulphonate compound (b) is an alkaryl sulphonate of formula (II):

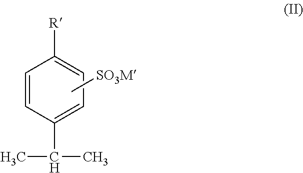

The present invention makes it possible to overcome the drawbacks of the prior art. More particularly it supplies surfactant compositions that can be adapted easily to various operating conditions, and in particular to various conditions of salinity, in order to provide optimum enhanced oil recovery. These surfactant compositions are particularly useful for enhanced oil recovery in conditions of low salinity, i.e. for example a salinity between 0.1 and 2 g/L, and in particular between 0.5 and 1.5 g/L.

This is achieved with the combined use, in one and the same composition, of an alkaryl sulphonate compound constituting a hydrophilic pole, i.e. having a high optimum salinity when it is used alone under standard conditions, and of an alkaryl sulphonate compound constituting a hydrophobic pole, i.e. having a low optimum salinity when it is used alone under standard conditions. Thus, for given operating conditions, and in particular for a given salinity and for a given type of hydrocarbons, it is easy to adjust the proportions of each of the two compounds to produce the conditions for the formation of a microemulsion comprising equal volumes of oil and water and thus optimize enhanced oil recovery.

As alkaryl sulphonate compound constituting the hydrophilic pole, i.e. having a high optimum salinity, preferably a compound of formula (I) is used, i.e. an alkylbenzene sulphonate; and as alkaryl sulphonate compound constituting the hydrophobic pole, i.e. having a low optimum salinity, preferably a compound of formula (II) is used, i.e. an alkylcumene sulphonate. Combining these two compounds permits particularly effective optimization of the composition.

### BRIEF DESCRIPTION OF THE DRAWINGS

FIG. 1 shows diagrammatically mixtures of Winsor type 1, 2 and 3.

FIG. 2 illustrates determination of the optimum salinity of a surfactant compound.

FIG. 3 illustrates determination of an optimum composition of surfactants for a given salt concentration and a given type of oil.

### DETAILED DESCRIPTION OF EMBODIMENTS

The following is a more detailed, non-limitative description of the invention.

General Definitions

The invention is based on the combination of a hydrophilic alkaryl sulphonate surfactant (a) and of a hydrophobic alkaryl sulphonate surfactant (b) within a surfactant composition.

By “alkaryl sulphonate” is meant any compound comprising a phenyl ring substituted with one or more alkyl groups as well as with a sulphonate group. Preferably, at least one alkyl substituent comprises at least 10 carbon atoms. In general, emulsified mixtures of aqueous solutions and liquid hydrocarbons (called oil hereinafter) can be classified in three categories:
The Winsor type 1 system is a two-phase system comprising a lower phase which is an oil-in-water microemulsion, and an upper phase having oil in excess. If a surfactant is present in the mixture, it is in the lower phase.
The Winsor type 2 system is a two-phase system comprising an upper phase which is a water-in-oil microemulsion, and a lower phase having water in excess. If a surfactant is present in the mixture, it is in the upper phase.
The Winsor type 3 system is a three-phase system comprising an upper phase having oil in excess, a lower phase having water in excess, and an intermediate phase which is a microemulsion consisting of water, of oil and of surfactant. The microemulsion is in equilibrium both with the aqueous phase and with the oily phase.

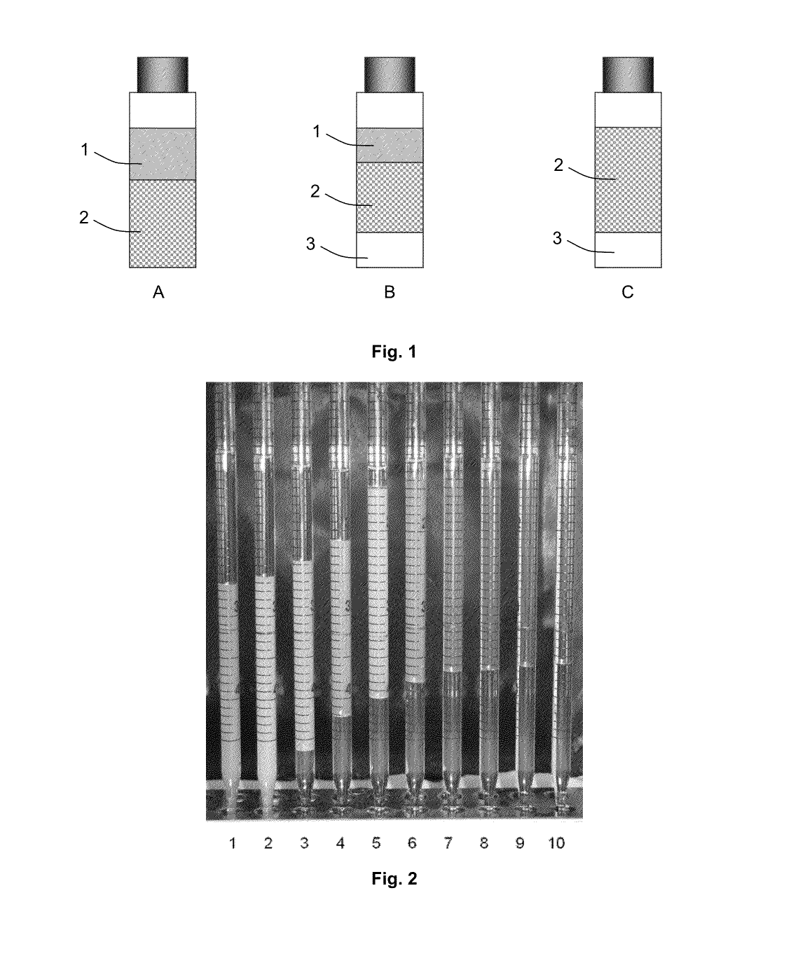

FIG. 1 illustrates the three types of systems. Test tube A shows a Winsor type 1 system, test tube B shows a Winsor type 3 system and test tube C shows a Winsor type 2 system. The oil phase is referenced with the number 1, the water phase with the number 3, and the microemulsion phase with the number 2.

When, in a Winsor type 3 system, the intermediate phase contains equal volumes of oil and water, the formulation of the system is qualified as optimum. For this particular formulation, simultaneous dissolution of the oil and of the water is maximum. It is known that these conditions correspond to a regime with low interfacial tensions (see Reed R. L.; Healy, R. N., Some physicochemical aspects of microemulsion floodings: a review. In Improved Oil Recovery by Surfactant and Polymer Flooding, Ed D. O. Shah; R. S. Schechter, Academic Press, New York, 1977, pp 383-437). To identify a mixture of Winsor type 3, and more particularly an optimum mixture of Winsor type 3, it is easiest to have recourse to visual inspection; it is possible, however, to use direct measurement of the interfacial tensions (by means of a tensiometer), for greater precision.

Hereinafter, the optimum salinity of a surfactant compound is defined as that concentration of sodium chloride in water at which said compound, when it is added for example at a content of 3.6% by weight of dry matter to an isovolumetric decane/water mixture, in the presence of 5.4% of secondary butanol, generates an optimum Winsor type 3 system, i.e. a three-phase mixture comprising:
an upper phase having decane (in excess);
a lower phase having water (in excess); and
an intermediate phase which is a microemulsion consisting of water, decane and said compound;

and in which the intermediate phase has an equal volume of decane and water.

The optimum salinity of a surfactant compound is determined by mixing, in graduated test tubes, equal volumes of water (2 ml), of decane (2 ml) and the surfactant, with increasing concentrations of sodium chloride. The concentration of surfactant is 3.6% (by weight of active substance of surfactant). A co-surfactant, secondary butanol, is also present at a concentration of 5.4%. The tests are carried out at atmospheric pressure, and at 50° C. The test tube in which an optimum Winsor type 3 system is present is identified (typically by visual inspection): the concentration of sodium chloride used in this test tube is the optimum salinity of the surfactant compound in question.

FIG. 2 illustrates determination of the optimum salinity of an alkaryl sulphonate surfactant compound according to the procedure described above. The figure shows a set of graduated test tubes containing mixtures of water and decane, with an increasing salt concentration.

Test tubes No. 1 and 2 (on the left) contain systems of Winsor type 1 (two-phase system with an upper phase of the oil type and a lower phase of the oil-in-water microemulsion type). The surfactant compound is therefore hydrophilic for the corresponding salt concentrations. Test tubes No. 6, 7, 8, 9 and 10 (on the right) contain systems of Winsor type 2 (two-phase system with a lower aqueous phase and an upper phase of the water-in-oil microemulsion type). The surfactant compound is therefore hydrophobic for the corresponding salt concentrations. Test tubes No. 3, 4 and 5 (in the centre) contain a Winsor type 3 system (three-phase system with an intermediate microemulsion phase).

Test tube No. 4 shows the optimum formulation, i.e. for the corresponding particular salt concentration, the microemulsion of the intermediate phase comprises as much oil as water. This test tube is identified by the fact that the volume of the microemulsion is distributed symmetrically on either side of a reference mark separating the total volume of the three phases into two equal parts. This salt concentration is therefore the optimum salinity of the surfactant compound.

Selection of a Suitable Surfactant Composition

The surfactant compositions according to the invention are selected so as to optimize enhanced oil recovery under particular operating conditions. Thus, the invention provides a method of obtaining an effective surfactant composition, as a function of the operating conditions, in particular as a function of the nature and composition of the underground formation considered.

The method of obtaining a surfactant composition suitable for enhanced oil recovery from an underground formation, according to the invention, comprises:
supplying a plurality of candidate surfactant compositions, each comprising a first alkaryl sulphonate compound (a) and a second alkaryl sulphonate compound (b), the two compounds (a) and (b) having different hydrophilicity; and
testing the effectiveness of each candidate surfactant composition in the presence of liquid hydrocarbons obtained from the underground formation in question.

Regarding the first step of supplying a plurality of candidate surfactant compositions, it may be useful to select a single compound (a) that can constitute a hydrophilic pole and a single compound (b) that can constitute a hydrophobic pole, the different surfactant compositions being obtained by varying the weight ratio of compounds (a) and (b) in the compositions. The hydrophilic or hydrophobic character of a surfactant compound depends on the actual operating conditions. A practical method for defining this hydrophilic or hydrophobic character consists of referring to the salinity of the underground formation.

As compound (a) that can constitute a hydrophilic pole, it is advantageous to select an alkaryl sulphonate compound having an optimum salinity greater than or equal to the salinity of the underground formation, and as compound (b) that can constitute a hydrophobic pole, it is advantageous to select an alkaryl sulphonate compound having an optimum salinity less than or equal to the salinity of the underground formation. The salinity of the underground formation in the sense of the present application is estimated as equivalent theoretical salinity of sodium chloride of the underground formation. This estimate is made by referring to a conductivity or to an equivalent ionic strength. Alternatively, the hydrophilic or hydrophobic character of a composite surfactant can be determined by measuring or calculating the HLB (Hydrophilic-Lipophilic Balance) or by direct measurement of the interfacial tension.

Regarding the second step of testing the effectiveness of each candidate surfactant composition, the latter has the aim of evaluating the behaviour of each candidate surfactant composition under conditions as close as possible to the actual operating conditions. The surfactant composition retained at the end of the second step depends on the physicochemical conditions considered, in particular the characteristics of the oil and of the water in the underground formation. For this, candidate mixtures are prepared by mixing each candidate surfactant composition with an aqueous solution having a salinity equal to the estimated salinity of the underground formation, and with a sample of liquid hydrocarbons obtained from the underground formation.

In concrete terms, the various candidate surfactant compositions (comprising for example variable relative proportions of two single compounds (a) and (b)) are put in graduated test tubes in the presence of equal volumes of water (2 ml, at the estimated salinity of the underground formation) and of hydrocarbons (2 ml, oil obtained from the underground formation). The concentration of the surfactant composition is for example between 0.5 and 2%.

Then the candidate mixtures are evaluated by visual inspection, checking whether they form systems of Winsor type 1, 2 or 3. A surfactant composition that supplied a candidate mixture forming a Winsor type 3 system is retained. If several systems of Winsor type 3 are obtained, preferably the surfactant composition is retained for which the mixture is of the optimum Winsor type 3, i.e. in which the intermediate phase contains equal volumes of oil and water. In practice, the test tube will be selected in which the intermediate microemulsion phase is distributed symmetrically on either side of a reference mark separating the internal volume of the test tube into two equal volumes.

The surfactant composition thus retained is the one for which the interfacial tensions, between the microemulsion and the oil on the one hand, and the microemulsion and the water on the other hand, are equal. If tests allow identification of several surfactant compositions making it possible to generate an optimum mixture of Winsor type 3, the surfactant composition will be selected for which the intermediate microemulsion phase has the largest volume.

In order to identify a mixture of Winsor type 3, and more particularly an optimum mixture of Winsor type 3, direct measurement of the interfacial tensions (by means of a tensiometer) can optionally be employed, for greater precision. If no system of Winsor type 3 can be identified, another pair of compounds (a) and (b) is selected to form a new set of candidate surfactant compositions.

In certain cases, estimation of the salinity of the underground formation (i.e. of the theoretical equivalent sodium chloride concentration of the underground formation) can give rise to uncertainty. It is then possible to perform several tests at different salt concentrations, so as to determine a surfactant composition that gives rise to a Winsor type 3 system for each of the different salt concentrations tested.

The above method makes it possible to select an ideal surfactant composition for given operating conditions. To select the surfactant composition, the tests are carried out at atmospheric pressure and at the temperature of the deposit (with the oil from the deposit, and a salt concentration equivalent to that of the deposit). Selection of the surfactant composition can be refined by adding, to the aqueous medium, the various additives that will be used in the actual operating conditions.

The concentration of surfactant used is typically 1% by weight. In any case, selection of the composition can also be refined for different concentrations of surfactants (for example from 0.2% to 2%). The surfactant composition selected has a hydrophilic pole (for the operating conditions considered), namely compound (a), and a hydrophobic pole (for the operating conditions considered), namely compound (b), adjusted optimally.

Thus, the hydrophilic compound generates, with the oil and water in the underground formation considered, systems of Winsor type 1. The hydrophobic compound generates, with the oil and water in the underground formation considered, systems of Winsor type 2. And the surfactant composition comprising both compounds generates, with the oil and water in the underground formation considered, systems of Winsor type 3, preferably optimum.

Surfactant Compositions According to the Invention

In general, the surfactant compositions according to the invention, the effectiveness of which, depending on the operating conditions, can be determined according to the method described above, comprise an alkaryl sulphonate surfactant compound (a) of the hydrophilic type and an alkaryl sulphonate compound (b) of the hydrophobic type. Consequently, the optimum salinity of compound (a) is greater than the optimum salinity of compound (b). More precisely, compounds (a) and (b) generally have optimum salinities that are relatively far apart. Thus, the surfactant compositions according to the invention are generally characterized by a difference in optimum salinity between compound (a) and compound (b) greater than or equal to 3 g/L, preferably greater than or equal to 5 g/L, ideally greater than or equal to 10 g/L.

In general, a surfactant compound (a) having an optimum salinity above 8 g/L is sufficiently hydrophilic, because for a salinity (concentration of sodium chloride) below 8 g/L the surfactant compound will preferentially be in the aqueous phase, and a surfactant compound (b) having an optimum salinity below 5 g/L is sufficiently hydrophobic, because for a salinity (concentration of sodium chloride) above 5 g/L, the surfactant compound will preferentially be in the oily phase. Preferably, compound (a) is highly hydrophilic, i.e. its optimum salinity is above 10 g/L, preferably above 15 g/L. Preferably, compound (b) is highly hydrophobic, i.e. its optimum salinity is below 4 g/L, preferably below 3 g/L.

A particularly suitable type of compound (a) is an alkylbenzene sulphonate of formula (I) above. A particularly suitable type of compound (b) is an alkylcumene sulphonate of formula (II) above. The isopropyl group of the alkylcumene sulphonate compound opposes stacking of the molecules and therefore promotes mobility of the interfaces and coalescence phenomena, making it a particularly useful compound for the applications envisaged in the present application.

Typically, the composition comprises from 1 to 99% of compound (a), preferably from 40 to 95%, more particularly preferably from 60 to 90%, relative to the total weight of compounds (a) and (b). Typically, the composition comprises from 1 to 99% of compound (b), preferably from 5 to 60%, more particularly preferably from 10 to 40%, relative to the total weight of compounds (a) and (b). Preferably, the weight ratio of compound (a) to compound (b) is greater than 1.

Several forms of packaging are possible for the composition. The latter can be in dry form (for example as powder) or in liquid form, i.e. in aqueous solution, concentrated or diluted, i.e. to the nominal concentration used for enhanced oil recovery. Under the operating conditions, the concentration by weight of surfactants is typically between 0.1% and 2%.

The surfactant composition can also comprise other additives, in particular salts, additional surfactants (for example other alkaryl sulphonates or an alcohol such as diethylene glycol butyl ether or a polyethoxylated alcohol, so as to reduce the time to reach equilibrium of the systems), sacrificial agents, polymers for controlling mobility, an agent for pH adjustment (for example sodium carbonate). Control of the pH is essential to prevent the surfactants being trapped by rocks, and especially clays, which can be positively charged. In the context of the present application, all proportions are expressed by weight, unless stated otherwise.

Compounds of Formulae (I) and (II)

All the characteristics enumerated in the context of the application regarding the compound of formula (I) and the compound of formula (II) correspond to average values. In fact, the compound of formula (I) and the compound of formula (II), in the context of the application, do not have a single chemical structure, but correspond to a set of different chemical structures all corresponding to formula (I), or to formula (II), respectively. For example, the expression “group R comprises X carbon atoms” signifies, in the context of the application, “on average, group R comprises X carbon atoms”.

Preferred compounds of formula (I) are those in which group R comprises from 12 to 24 carbon atoms, and more particularly from 16 to 20 carbon atoms. Preferred compounds of formula (II) are those in which group R′ comprises from 10 to 24 carbon atoms, and more particularly from 14 to 18 carbon atoms. Groups R and R′ can be saturated or unsaturated, and are preferably saturated.

Groups R and R′ can be linear or branched. As average values, preferably from 10 to 60% of groups R are branched, more particularly from 20 to 50%, more particularly preferably from 30 to 40%. Still as average values, preferably from 0.5 to 20% of groups R′ are branched, preferably from 1 to 15%, more particularly preferably from 2 to 8%. In the compound of formula (II), group R′ is in the para position relative to the isopropyl group CH(CH₃)₂. The sulphonate group is in the ortho or meta position relative to group R′.

The compounds of formula (I) and (II) can also be characterized according to their content of 2-phenyl, i.e. according to the proportion of groups R (or R′) that are bound to the phenyl ring in position 2. Position 2 corresponds to the second carbon atom starting from any one of the ends of the longest carbon chain of group R (or of group R′). Preferably, in compound (I), from 1 to 50% of groups R are bound at their position 2, more particularly from 5 to 30%, more particularly preferably from 10 to 20%. Preferably, in compound (II), from 1 to 50% of groups R′ are bound at their position 2, more particularly from 5 to 30%, more particularly preferably from 10 to 20%.

Compounds having the characteristics of the degree of branching, content of 2-phenyl, number of carbon atoms etc. described above are particularly advantageous for supplying surfactant compositions that are effective for enhanced oil recovery, in particular at low salinity. The conjugated monovalent cations M and M′ of the sulphonate in formulae (I) and (II) are preferably alkali metal cations, in particular potassium or sodium, and more particularly sodium.

The distribution of the carbon chain and the proportion of groups bound to the phenyl ring in position 2 are determined according to standard UOP 673. Other characteristics of the above molecules can also be determined according to the usual standards, in particular the content of active substance (standard ISO 2271), the water content (standard ISO 4317) and the acid number (standard ISO 4314). The compounds of formula (I) and (II) can be obtained using the method described in document FR 2589858.

Using the Surfactant Compositions for Enhanced Oil Recovery

The surfactant compositions of the invention are particularly useful for enhanced oil recovery (EOR). For this purpose, a surfactant composition according to the invention, in the form of aqueous solution, is injected by means of an injection well into the underground formation containing hydrocarbons, and in particular crude oil. The surfactant composition displaces the petroleum, forming an oil/water microemulsion locally. This zone of low interfacial tension is then propagated through the formation. Optionally, water, hydrocarbon fluid or brine can be injected prior to the injection of the surfactant composition.

The hydrocarbons are recovered via one or more output wells remote from the injection well. The invention is particularly useful for the recovery of hydrocarbons that are conventional oils, preferably light, and that have for example the following characteristics:
equivalent alkane carbon number (EACN) between 6 and 15; and/or
API degree between 25 and 45.

### Examples

The following examples illustrate the invention but do not limit it.

### Example 1

A hydrophilic sodium alkylbenzene sulphonate compound of formula (I) is prepared by the method described above. This compound has the following characteristics:
chain length of group R: 18;
content of 2-phenyl: 15%;
proportion of branched groups R: 36%;
optimum salinity: 11 g/L.

A hydrophobic sodium alkylcumene sulphonate compound of formula (II) is prepared by the method described above. This compound has the following characteristics:
chain length of group R: 14;
content of 2-phenyl: 15%;
proportion of branched groups R: 5%;
optimum salinity: 3 g/L.

A mixture of these two surfactant compounds is tested in the presence of water containing 1.2 g/L of total salts and 6 g/L of sodium carbonate (for adjustment of the pH). The theoretical equivalent concentration of sodium chloride (NaCl) is estimated at 6 g/L. The theoretical salinity value is well within the range of the respective optimum salinities of the two compounds selected.

Tests are then carried out for determining the relative proportions of the two constituents of the mixture. For this purpose, 14 test tubes are filled with the isovolumetric water/petroleum mixture, to which a mixture of the two compounds is added in the following respective weight ratios of hydrophilic compound to hydrophobic compound: 80/20, 75/25, 70/30, 68/32, 66/34, 65/35, 64/36, 62/38, 60/40, 58/42, 56/44, 54/46, 52/48, 50/50.

It was found visually that the ratio 65/35 is the one that is able to give a Winsor 3 system, optimally with equal volumes of oil and water in the microemulsion phase. Consequently, the surfactant composition comprising, in relative quantities, 65% of the aforementioned sodium alkylbenzene sulphonate and 35% of the aforementioned sodium alkylcumene sulphonate is particularly effective for enhanced recovery of the petroleum in question, using the water in question.

### Example 2

The hydrophilic sodium alkylbenzene sulphonate compound of formula (I), described in Example 1, is used in this example. In addition, a hydrophobic sodium alkylcumene sulphonate compound of formula (II) is prepared by the method described above. This compound has the following characteristics:
chain length of group R: 16;
content of 2-phenyl: 15%;
proportion of branched groups R: 5%
optimum salinity: 1.7 g/L.

A mixture of these two surfactant compounds is tested in the presence of water containing 1.2 g/L of total salts and 6 g/L of sodium carbonate (for adjustment of the pH). The theoretical equivalent concentration of sodium chloride (NaCl) is estimated at 6 g/L. The theoretical salinity value is well within the range of the respective optimum salinities of the two compounds selected.

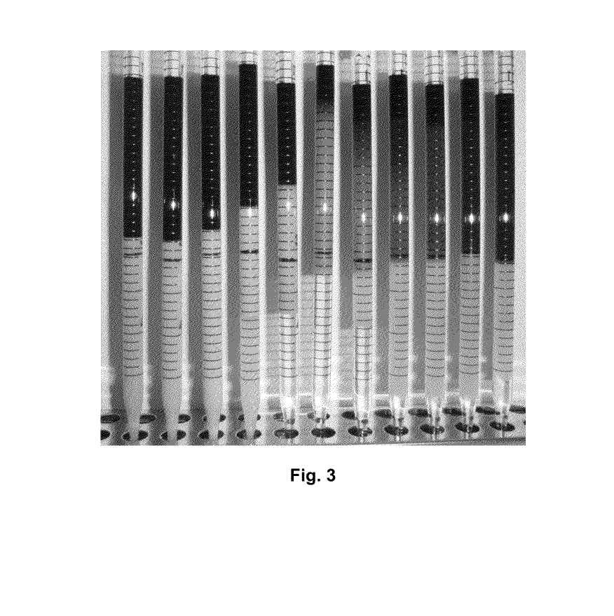

Tests are then performed for determining the relative proportions of the two constituents of the mixture. For this purpose, 11 test tubes are filled with an isovolumetric water/petroleum mixture, to which a mixture of the two compounds is added in the following respective weight ratios of hydrophilic compound to hydrophobic compound: 90/10, 87.5/12.5, 85/15, 82.5/17.5, 80/20, 77.5/22.5, 75/25, 72.5/27.5, 70/30, 67.5/32.5 and 65/35. This set of test tubes is shown, in the above order, in FIG. 3.

It was found visually that the ratio 80/20 is the one that is able to give a Winsor 3 system, optimally with equal volumes of oil and water in the microemulsion phase. Consequently, the surfactant composition comprising, in relative quantities, 80% of the aforementioned sodium alkylbenzene sulphonate and 20% of the aforementioned sodium alkylcumene sulphonate is particularly effective for enhanced recovery of the petroleum in question, using the water in question.

### Example 3

The hydrophilic sodium alkylbenzene sulphonate compound of formula (I), described in Example 1, is used in this example. In addition, a hydrophobic sodium alkylcumene sulphonate compound of formula (II) is prepared by the method described above. This compound has the following characteristics:
chain length of group R: 18;
content of 2-phenyl: 14%;
proportion of branched groups R: 6%
optimum salinity: 0.5 g/L.

A mixture of these two surfactant compounds is tested in the presence of water containing 1.2 g/L of total salts and 6 g/L of sodium carbonate (for adjustment of the pH). The equivalent theoretical salinity of sodium chloride (NaCl) is estimated at 6 g/L. The theoretical salinity value is well within the range of the respective optimum salinities of the two compounds selected.

Tests are then performed for determining the relative proportions of the two constituents of the mixture. For this purpose, 11 test tubes are filled with an isovolumetric water/petroleum mixture, to which a mixture of the two compounds is added in the following respective weight ratios of hydrophilic compound to hydrophobic compound: 100/0, 97.5/2.5, 95/5, 92.5/7.5, 90/10, 87.5/12.5, 85/15, 82.5/17.5, 80/20, 77.5/22.5 and 75/25.

It was found visually that the ratio 90/10 is the one that is able to give a Winsor 3 system, optimally with equal volumes of oil and water in the microemulsion phase. Consequently, the surfactant composition comprising, in relative quantities, 90% of the aforementioned sodium alkylbenzene sulphonate and 10% of the aforementioned sodium alkylcumene sulphonate is particularly effective for enhanced recovery of the petroleum in question, using the water in question.

1. A surfactant composition comprising:
an alkylaryl sulphonate compound (a); and
an alkylaryl sulphonate compound (b);
a difference between the optimum salinity of compound (a) and the optimum salinity of compound (b) being greater than or equal to 3 g/L;
the optimum salinity of a compound being defined as that concentration of sodium chloride in water at which the compound, when it is added at a content of 3.6% by weight of dry matter to an isovolumetric decane/water mixture, in the presence of 5.4% of secondary butanol, at atmospheric pressure and at 50° C., generates a three-phase mixture comprising:
an upper phase of decane;
a lower phase of water; and
an intermediate phase which is an emulsion consisting of water, decane and the compound;
in which the intermediate phase has an equal volume of decane and water.

2. The surfactant composition according to claim 1, in which the difference between the optimum salinity of compound (a) and the optimum salinity of compound (b) is greater than or equal to 5 g/L.

3. The surfactant composition according to claim 1, in which compound (b) has an optimum salinity below 5 g/L.

4. The surfactant composition according to claim 1, in which compound (a) has an optimum salinity above 8 g/L.

5. A surfactant composition comprising:
an alkylaryl sulphonate compound of formula (I): 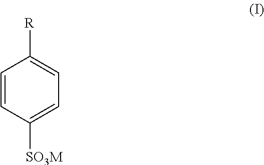
and an alkylaryl sulphonate compound of formula (II): 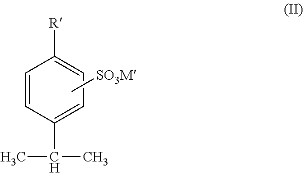
R and R′ each representing an alkyl group, and M and M′ each representing a monovalent cation.

6. The surfactant composition according to claim 5, in which at least one of:
in the compound of formula (I), group R comprises from 12 to 24 carbon atoms; and/or
in the compound of formula (II), group R′ comprises from 10 to 24 carbon atoms.

7. The surfactant composition according to claim 5, in which M and M′ are each a sodium cation.

8. The composition according to claim 5, in which at least one of:
in compound (I), from 1 to 50% of groups R are bound at their position 2, and/or
in compound (II), from 1 to 50% of groups R′ are bound at their position 2.

9. The surfactant composition according to claim 5, in which at least one of:
in compound (I), from 10 to 60% of groups R are branched; and/or
in compound (II), from 0.5 to 20% of groups R′ are branched.

10. The surfactant composition according to claim 5, comprising at least one of:
from 1 to 99% of compound (I), relative to the total weight of compounds (I) and (II); and/or
from 1 to 99% of compound (II), relative to the total weight of compounds (I) and (II).

11. The surfactant composition according to claim 5, in which a difference between the optimum salinity of compound (I) and an optimum salinity of compound (II) is greater than or equal to 3 g/L, the optimum salinity of a compound being defined as that concentration of sodium chloride in water at which said compound, when it is added at a content of 3.6% by weight of dry matter to an isovolumetric decane/water mixture, in the presence of 5.4% of secondary butanol, at atmospheric pressure and at 50° C., generates a three-phase mixture comprising:
an upper phase of decane;
a lower phase of water; and
an intermediate phase which is an emulsion consisting of water, decane and the compound;
in which the intermediate phase has an equal volume of decane and water.

12. The surfactant composition according to claim 11, in which at least one of:
compound (I) has an optimum salinity greater than or equal to 8 g/L; and/or
compound (II) has an optimum salinity less than or equal to 5 g/L.

13. (canceled)

14. The surfactant composition according to claim 1, wherein the composition is in one of: a dry form or a form of aqueous solution, the proportion by weight of alkylaryl sulphonates in the aqueous solution.

15. A method of extracting hydrocarbons from a subterranean formation, comprising an injection of the surfactant composition according to claim 1 in the form of aqueous solution into the subterranean formation, and the production of hydrocarbons displaced by the injected surfactant composition.

16. A method of obtaining a surfactant composition suitable for enhanced oil recovery from a subterranean formation, the method comprising:
estimating the salinity of the subterranean formation;
supplying a plurality of candidate surfactant compositions, each comprising a first alkylaryl sulphonate compound (a) and a second alkylaryl sulphonate compound (b);
mixing each candidate surfactant composition with an aqueous solution having a salinity equal to the estimated salinity of the subterranean formation, and with a sample of liquid hydrocarbons obtained from the subterranean formation, for supplying a candidate mixture;
selecting a surfactant composition from the set of candidate surfactant compositions, the candidate mixture combined with the selected surfactant composition being a three-phase mixture comprising:
an upper phase of liquid hydrocarbons;
a lower phase of aqueous solution; and
an intermediate phase which is an emulsion comprising aqueous solution, of liquid hydrocarbons and of compounds (a) and (b).

17. The method according to claim 16, in which the intermediate phase of the candidate mixture combined with the surfactant composition selected comprises an equal volume of liquid hydrocarbons and aqueous solution.

18. The method according to claim 16, comprising:
after estimating the salinity of the subterranean formation:
selecting an alkylaryl sulphonate compound having an optimum salinity higher than the estimated salinity of the subterranean formation, as alkylaryl sulphonate compound (a) for all of the candidate surfactant compositions; and
selecting an alkylaryl sulphonate compound having an optimum salinity lower than the estimated salinity of the subterranean formation, as alkylaryl sulphonate compound (b) for all of the candidate surfactant compositions;
and in which the weight ratio of alkylaryl sulphonate compound (a) to alkylaryl sulphonate compound (b) varies depending on the candidate surfactant compositions;
the optimum salinity of a compound being defined as that concentration of sodium chloride in water at which the compound, when it is added at a content of 3.6% by weight of dry matter to an isovolumetric decane/water mixture, in the presence of 5.4% of secondary butanol, at atmospheric pressure and at 50° C., generates a three-phase mixture comprising:
an upper phase of decane;
a lower phase of water; and
an intermediate phase which is an emulsion consisting of water, decane and the compound;
in which the intermediate phase has an equal volume of decane and water.

19. The method according to claim 18, in which the difference between the optimum salinity of compound (a) and the optimum salinity of compound (b) is greater than or equal to 3 g/L.

20. The method according to claim 16, in which the alkylaryl sulphonate compound (a) is an alkylaryl sulphonate of formula (I): 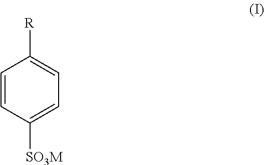
and the alkylaryl sulphonate compound (b) is an alkylaryl sulphonate of formula (II): [chemical structure]
